(19) United States
(12) Patent Application Publication
(10) Pub. No.: US 2024/0353146 A1
(43) Pub. Date: Oct. 24, 2024

(54) HEAT CONDUCTING ELEMENT FOR USE WITH A HEATED CONVEYOR PUMP

(71) Applicant: Bleckmann GmbH & Co. KG, Lamprechtshausen (AT)

(72) Inventors: Mladen GOJKIC, Salzburg (AT); Aljbert LJATIFI, Salzburg (AT)

(21) Appl. No.: 18/641,103

(22) Filed: Apr. 19, 2024

(30) Foreign Application Priority Data
Apr. 21, 2023 (EP) 23169141.1

(51) Int. Cl. F24H 9/1818; F24H 15/25; F24H 15/37

(52) U.S. Cl. CPC F24H 9/1818; F24H 15/25; F24H 15/37

(57) ABSTRACT

The present invention relates to a heat conducting element which comprises a first heat capturing portion configured to be thermally coupled to a heating unit of the heated conveyor pump; a second heat capturing portion configured to be thermally coupled to a medium leading section of a carrier unit of the heated conveyor pump; and at least one measurement portion positioned between the first heat capturing portion and the second heat capturing portion and configured to be thermally coupled to a temperature sensing unit. The first heat capturing portion extends from the measurement portion in a first direction and the second heat capturing portion extends from the measurement portion in a second direction such that the first and second heat capturing portions are arranged on opposite sides of the measurement portion. The present invention also relates to a method for manufacturing a heat conducting element.

### CROSS-REFERENCE TO RELATED APPLICATION

The present application claims the benefit of priority of European Patent Application No. 23169141.1 filed Apr. 21, 2023, the content of which is incorporated herein by reference in its entirety.

### FIELD OF THE INVENTION

The present invention relates to the field of household appliances, and in particular to aspects of a heat conducting element for use in a heating system component of a heated conveyor pump for use in a household appliance, such as a dishwasher or a washing machine.

### BACKGROUND OF THE INVENTION

In many types of domestic (household) appliances or domestic (household) machines, it is necessary to heat up a fluid medium, such as for example water. For the purpose of heating up the medium, commonly a heating system component with a heating unit is provided, wherein the medium is thermally coupled to the heating unit.

From FIGS. 1A-1C and associated description of our WO 2022/117779 A2 (WO'779), there is known a heated conveyer pump 10. Heated conveyer pump 10 comprises a pump housing 12 accommodating an impeller 14. Heated conveyer pump 10 also comprises a drive unit 16 for driving impeller 14, wherein the drive unit 16 is configured to be attached to the pump housing 12 from the outside such that the drive unit 16, the pump housing 12, and the impeller 14 are arranged coaxially along a common central longitudinal axis 17. Heated conveyer pump 10 further comprises a heating system component 18.

FIG. 1B of WO'779 shows heated conveyer pump 10 shown in FIG. 1A in an assembled state. Heating system component 18 is configured to be attached into an opening of pump housing 12 such that heating system 18 and pump housing 12 define a volume that is adapted to receive a medium. The medium can be a liquid such as water, oil, gasoline, or a cleaning solvent. For example, the medium may be water to be heated for use in a dishwashing machine or washing machine.

Drive unit 16 is configured to drive impeller 14. Impeller 14 shown in FIG. 1B of WO'779 is configured to rotate in a way that generates a pressure in the medium that causes the medium to flow through pump housing 12. To this end, a first pipe 20 is attached into an opening of heated conveyer pump 10. A second pipe 22 is attached to an opening of pump housing 12. Driven by pressure created by impeller 14, a liquid medium 24 is sucked into first pipe 20, conveyed through pump housing 12 and released out of second pipe 22. FIG. 1C of WO'779 shows a heated conveyer pump 10 with an opposite medium flow, wherein medium 24 is sucked into second pipe 22 and released out of first pipe 20.

As shown e.g. in FIGS. 2, 3, 5A-5C, FIGS. 11A-15C of WO'779, heating system component 18 comprises a carrier unit 26 having a first side 38, a second side 40 (cf. e.g. FIG. 15B of WO'779), a groove 34 provided on first side 38, and a liquid medium leading section 42 at least partially opposite a medium flow area on the second side 40 and a heating unit 28 at least partially received in groove 34. Second side 40 is also referred to as wet side 40, because when assembled into heated conveyor pump 10 (cf. e.g. FIGS. 1A-1C of WO'779), it faces the inside of a pump housing 12 and can therefore come into contact with the pumped liquid medium 24, such as water. In other words, when in operation, second side 40 is generally wetted by the pumped liquid medium 24, such as water. In turn, first side 38 can also be referred to as dry side 38, because it is not in contact with the pumped liquid medium 24, such as water.

Heating system component 18 further comprises a heating unit 28 that is thermally coupled to liquid medium 24 inside pump housing 12. Heating unit 28 is configured to generate heat, which is transferred to liquid medium 24 inside pump housing 12. Heated conveyer pump 10 is consequently configured to convey the liquid medium through pump housing 12 due to a pressure generated by impeller 14 and to heat up liquid medium 24 with heat generated by heating unit 28 while liquid medium 24 passes through pump housing 12.

Heating unit 28 generates heat and flowing liquid medium 24 removes heat, wherein different rates of heat generation, medium flow and filling level of pump housing 12 differently influence the temperature liquid medium 24 reaches when released out of heated conveyer pump 10. Heating system component 18 comprises a temperature sensor that allows determining the temperature of liquid medium 24 and heating unit 28.

FIG. 3 of WO'779 shows heating system component 18 shown in FIG. 2 of WO'779 with an exploded view of temperature sensor assembly 30. Temperature sensor assembly 30 comprises a heat conducting plate assembly 46, a printed circuit board 48, a housing 50, and a biasing element 52, which in the example shown in FIG. 3 of WO'779 comprises two metal springs.

A particular design for heat conducting plate assembly 46 is shown in FIG. 16B of WO'779, reproduced herein as FIG. 1. Moreover, FIG. 15A of WO'779-reproduced herein as FIG. 2—shows a top view of heating system component 18 comprising heat conducting plate assembly 46.

Heat conducting plate assembly 46 comprises a first heat capturing plate portion 54 that is thermally coupled to heating unit 28, a second heat capturing plate portion 56 that is thermally coupled to medium leading section 42 of carrier unit 26, a first heat releasing plate portion 58, and a second heat releasing plate portion 60. Carrier unit 26 comprises the form of a circular disc having a central axis, and wherein recess 62 of heat conducting plate assembly 46 extends at least partially in circumferential direction with respect to the central axis of circular disc of carrier unit 26.

The purpose of heat conducting plate assembly 46 is to enable temperature sensor assembly 30 of WO'779 to simultaneously determine a temperature of liquid medium 24 and of heating unit 28. To summarize the teaching of WO'779, heat from heating unit 28 is transferred to first heat capturing plate portion 54 which is thermally coupled to heating unit 28. From there on, heat from heating unit 28 is transferred to first heat releasing plate portion 58, which is configured to be coupled to a first temperature sensor area 72 (cf. e.g. FIG. 6 of WO'779) of sensor assembly 30, at which circuitry 70 is provided which is configured to sense the temperature (a first temperature) at first heat releasing plate portion 58. The first temperature is therefore indicative of the temperature of heating unit 28 and can be used to determine or as a substitute for the temperature of heating unit 28.

Likewise, heat from liquid medium 24 is transferred via medium leading section 42 at the surface of dry side 38, to second heat capturing plate portion 56 which is thermally coupled to medium leading section 42 at the surface of dry side 38. From there on, heat from liquid medium 24 is transferred to second heat releasing plate portion 60, which is configured to be coupled to a second temperature sensor area 74 (cf. e.g. FIG. 6 of WO'779) of sensor assembly 30, at which circuitry 70 is provided which is configured to sense the temperature (a second temperature) at second heat releasing plate portion 60. The second temperature is therefore indicative of the temperature of liquid medium 24 and can be used to determine or as a substitute for the temperature of liquid medium 24.

Despite the satisfying performance of heat conducting plate assembly 46 known from WO'779, there remains a need for improvements.

In particular, heat capturing plate portions 54 and 56 are not fully thermally decoupled, i.e. if there is a temperature gradient between plate portion 54 and 56, heat will flow to equalize the temperature gradient. This heat flow can be conductive (i.e. by heat conduction through heat conducting plate assembly 46), convective (i.e. by convection of air or other medium surrounding heat conducting plate assembly 46) or by radiation. As a result of such heat flow, the temperatures of heat capturing plate portions 54 and 56 influence one another, meaning they are not exclusively representative of the temperature of liquid medium 24 and heating unit 28, respectively. This will result in an error when using the temperatures measured at first and second heat releasing plate portions 58, 60 to determine the temperatures of medium 24 and heating unit 28, respectively.

Conductive heat flow between heat capturing plate portions 54 and 56 through heat conducting plate assembly 46 is particularly problematic, as it may result in heat from first heat capturing plate portion 54 being transferred to second heat release portion 60, or heat from second heat capturing plate portion 56 being transferred to first heat release portion 58. Moreover, heat may flow between heat release portions 58, 60. Thus, the temperatures of heat release portions 58, 60 are not exclusively representative of the temperature of first and second heat capturing plate portions 54, 56, respectively. As a result, a further error is introduced when using the temperatures measured at first and second heat releasing plate portions 58, 60 to determine the temperatures of medium 24 and heating unit 28, respectively.

In view of these and other drawbacks, it is an object of the present application to improve the devices and methods disclosed in WO'779.

### SUMMARY OF THE INVENTION

In view of these and other drawbacks, it is an object of the present application to improve the devices and methods disclosed in WO'779. Therefore, the present application discloses the following aspects:

### First Aspect

According to a first aspect, the problem is solved by providing a heat conducting element as defined in independent claim 1.

The heat conducting element of the first aspect comprises a first heat capturing portion configured to be thermally coupled to a heating unit of the heated conveyor pump; a second heat capturing portion configured to be thermally coupled to a medium leading section of a carrier unit of the heated conveyor pump; and at least one measurement portion positioned between the first heat capturing portion and the second heat capturing portion and configured to be thermally coupled to a temperature sensing unit. The first heat capturing portion extends from the measurement portion in a first direction and the second heat capturing portion extends from the measurement portion in a second direction such that the first and second heat capturing portions are arranged on opposite sides of the measurement portion.

Positioning the measurement portion between the first and second heat capturing portions, and arranging the first and second heat capturing portions on opposite sides thereof brings a number of advantages, in particular compared with the prior art design of heat conducting plate assembly 46 shown in FIGS. 1 and 2. As can be inferred from FIGS. 1 and 2, first and second heat capturing plate portions 54, 56 of prior art heat conducting plate assembly 46 are positioned on the same side of the portion of heat conducting plate assembly 46 which provides first and second heat release portions 58, 60 (i.e. the measurement portion). Thus, some heat is transferred between first and second heat capturing plate portions 54, 56 which bypasses first and second heat release portions 58, 60 (i.e. the measurement portion).

For example, since a direct line of sight exists between first and second heat capturing plate portions 54, 56, heat can be directly radiated between first and second heat capturing plate portions 54, 56. This direct line of sight also provides a shortest path for convective heat flow between first and second heat capturing plate portions 54, 56. Moreover, since first and second heat capturing plate portions 54, 56 are positioned on the same side of the portion of heat conducting plate assembly 46 which provides first and second heat release portions 58, 60 (i.e. the measurement portion), their distance is comparable to the distance between a respective heat capturing plate portion and its associated heat release portion. As such, the temperature gradient dT/dx which drives the conductive rate of heat flow per area \dot{q} according to Fourier's law of heat conduction

$$\dot{q} = - λ \frac{dT}{dx} ,$$

where λ is the thermal conductivity, between first and second heat capturing plate portions 54, 56 becomes comparable to the distance between a respective heat capturing plate portion and its associated heat release portion. As a result, the rate of heat flow per area between first and second heat capturing plate portions 54, 56 becomes comparable to the rate of heat flow per area between a respective heat capturing plate portion and its associated heat release portion, resulting in an error when using the temperatures measured at first and second heat releasing plate portions 58, 60 to determine the temperatures of medium 24 and heating unit 28, respectively.

The first aspect at least mitigates this error by positioning the measurement portion between the first and second heat capturing portions, and arranging the first and second heat capturing portions on opposite sides thereof. Thereby, the measurement portion, and the temperature sensing unit when coupled to the measurement portion, at least partially obstruct the line of sight between the first and second heat capturing portions, reducing heat transfer by radiation and/or convection between the first and second heat capturing portions. Moreover, this design increases the distance between the first and second heat capturing portions in comparison to the distance between each heat capturing plate portion and the measurement portion, ensuring that the temperature gradient between the first and second heat capturing portions is smaller than that between each heat capturing plate portion and the measurement portion. As a result, the conductive heat transfer between first and second heat capturing portions is reduced, and it is ensured that the transferred heat does not bypass the measurement portion.

Particularly preferred embodiments of the first aspect are defined in dependent claims 2 to 13.

Further preferred embodiments of the first aspect will be described in the following together with the drawings listed below. Further advantages, implementations and embodiments of the first aspect will be detailed therein. The following description together with the drawings are therefore fully referenced for the purpose of detailing the previous description of the first aspect. It has to be understood that any of the individual features described in the following and/or shown in the drawings can be combined with, or replace corresponding features of any of the embodiments of the first aspect discussed above. Moreover, it has to be understood that the fact that a certain feature is recited by an independent claim and/or the description of the first aspect, is not sufficient to indicate whether or not the feature is an essential feature.

### Second Aspect

According to a second aspect, the problem is solved by providing a method of manufacturing a heat conducting element as defined in independent claim 14.

The method of the second aspect is particularly advantageous for providing a heat conducting element having a three dimensional shape, such as a heat conducting element of the first aspect, in a cost efficient manner.

A particularly preferred embodiment of the second aspect is defined in dependent claim 15.

Further preferred embodiments of the second aspect will be described in the following together with the drawings listed below. Further advantages, implementations and embodiments of the second aspect will be detailed therein. The following description together with the drawings are therefore fully referenced for the purpose of detailing the previous description of the second aspect. It has to be understood that any of the individual features described in the following and/or shown in the drawings can be combined with, or replace corresponding features of any of the embodiments of the second aspect discussed above. Moreover, it has to be understood that the fact that a certain feature is recited by an independent claim and/or the description of the second aspect, is not sufficient to indicate whether or not the feature is an essential feature.

### BRIEF DESCRIPTION OF THE DRAWINGS

FIG. 1 depicts a heat conducting plate assembly according to the prior art as disclosed in WO'779;

FIG. 2 shows a heating system component according to the prior art as disclosed in WO'779;

FIG. 3 provides a perspective view of a heated conveyor pump comprising a heating system component including an embodiment of a heat conducting element of the first aspect;

FIG. 4 provides a perspective view of the heating system component of FIG. 3;

FIG. 5A is a top view of the heating system component of FIG. 3;

FIG. 5B is a cross sectional view along line A-A in FIG. 5A;

FIG. 6A provides a perspective view on an embodiment of a heat conducting element of the first aspect with a temperature sensing unit coupled to a measurement portion of the heat conducting element, and a grounding connector protruding through a slit in the heat conducting element;

FIG. 6B shows the heat conducting element of FIG. 6A with the temperature sensing unit and the grounding connector removed;

FIG. 7A is a perspective view of a back side of the heat conducting element and temperature sensing unit of FIG. 6A;

FIG. 7B provides the same perspective view as FIG. 7A with the temperature sensing unit removed;

FIG. 7C provides the same perspective view as FIGS. 7A and 7B with a sensor board of the temperature sensing unit visible;

FIG. 7D provides the same perspective view as FIGS. 7A, 7B and 7C, with a sensor board of the temperature sensing unit and a biasing element visible;

FIG. 8 provides a view on an embodiment of a heat conducting element of the first aspect from a direction of the second heat capturing portion perpendicular onto the measurement portion;

FIG. 9 provides the same perspective as FIG. 8, albeit on a further embodiment of a heat conducting element of the first aspect;

FIG. 10 provides a top view on a flat piece of material, which can be manufactured into a heat conducting element of the first aspect by a method of the second aspect;

FIG. 11A is a perspective cross-sectional view of a first heat capturing portion including a temperature sensing unit coupled to a connecting portion and a biasing element received in a biasing element receiving portion; and

FIG. 11B is another perspective view of the cross section of FIG. 11A.

### DETAILED DESCRIPTION OF PREFERRED EMBODIMENTS IN THE DRAWINGS

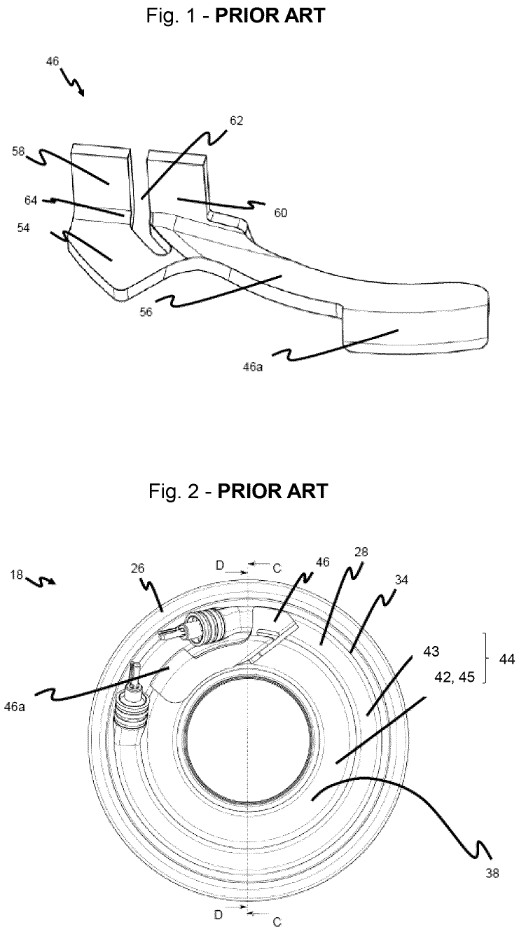

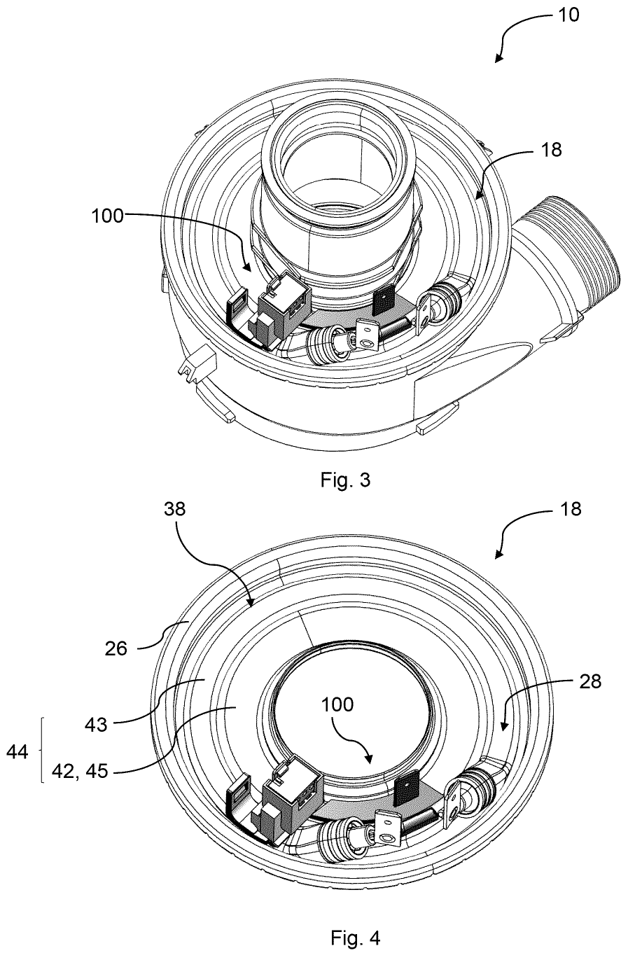

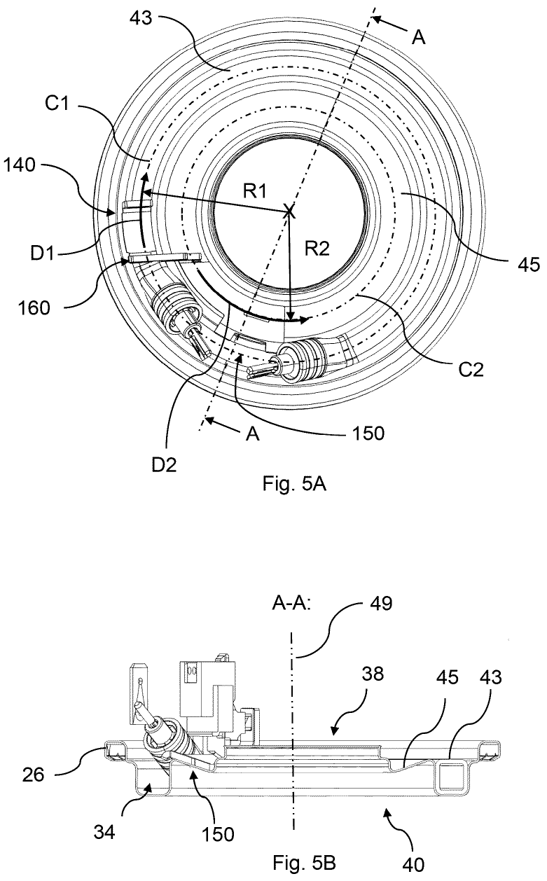

FIG. 3 shows a heated conveyor pump 10 comprising a heating system component 18 including heat conducting element 100, which is an embodiment of the first aspect. FIGS. 4, 5A and 5B show heating system component 18 without the remaining components of heated conveyor pump 10, but including heat conducting element 100, which is an embodiment of the first aspect. With the exception of heat conducting element 100, conveyor pump 10 and heating system component 18 are identical to conveyor pump and heating system component 18 disclosed in WO'779. For details regarding conveyor pump 10 and heating system component 18 it is therefore referred to WO'779, the content of which is incorporated by reference in its entirety. Moreover, specifics of heating system component 18 have been described above in the section “BACKGROUND OF THE INVENTION” with reference to WO'779 and FIGS. 1 and 2 of the present application. The above description in the section “BACKGROUND OF THE INVENTION” is therefore fully referenced for the purposes of FIGS. 3, 4, 5A and 5B. In particular, the reference signs used in FIGS. 3, 4, 5A and 5B for elements of heating system component 18, with the exception of heat conducting element 100, correspond to those used in FIG. 2 and in WO'779.

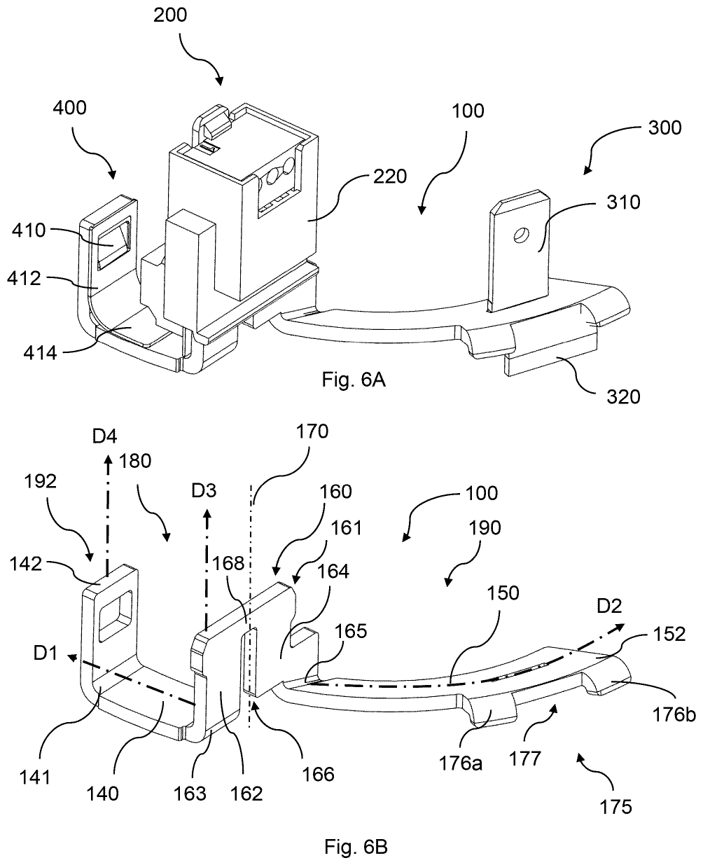

FIGS. 6A through 9 show various embodiments of a heat conducting element 100 according to the first aspect. Heat conducting element 100 comprises three main elements, a first heat capturing a portion 140, a second heat capturing portion 150 and a measurement portion 160. First heat capturing portion 140 extends from measurement portion 160 in a first direction of D1 and second heat capturing portion 150 extends from measurement portion 160 in a second direction D2, such that the first and second heat capturing portions 140, 150 are arranged on opposite sides of measurement portion 160.

In some embodiments, such as those depicted in the figures, the opposite sides of measurement portion 160 can also be referred to as a front side and a back side. From the perspective of FIGS. 6A and 6B for example, first heat capturing portion 140 is arranged on a back side of measurement portion 160, and second heat capturing portion 150 is arranged on a front side of measurement portion 160. More generally, in preferred embodiments, the opposite sides of measurement portion 160 from which first and second heat capturing portions 140, 150 extend, are sides of measurement portion 160 which are facing away from each other. In other words, the two opposite sides are arranged such that a normal vector of one of the two opposite sides and a normal vector of the other of the two opposite sides enclose an angle of greater than 90 degrees. In this context, the enclosed angle refers to a shortest angle between the two vectors at which any of the two vectors is rotated about the other vector such that both of the vectors have the same direction.

In the depicted embodiments, all portions of heat conducting element 100 are substantially plate-like, meaning that a thickness of a portion is small compared to a width and a length of the portion. Consequently, a thickness of a portion is understood as the smallest of the three dimensions-length, width, and thickness—of the portion. In preferred embodiments, such as those depicted in the figures, the thicknesses of the portions of heat conducting element 100 are substantially equal. As detailed later in conjunction with the manufacturing method of the second aspect and FIG. 10, such a constant thickness can be a result of forming a three-dimensionally shaped heat conducting element 100, such as those depicted in the figures, from a substantially flat piece of material as shown in FIG. 10. In the context of the present application, a portion of heat conducting element 100 extends in a certain direction, if a thickness of the portion is substantially orthogonal to the direction in which the portion extends. For example, as shown in FIG. 6B, first heat capturing portion 140 extends in first direction D1, because a thickness of first heat capturing portion 140 is orthogonal to first direction D1. More preferably, a portion of heat conducting element 100 extends in a certain direction, if—in addition to the thickness being orthogonal to the direction—a length of the portion is substantially aligned with the direction. In this context, a length of the portion is understood as the largest of the three dimensions—length, width, and thickness—of the portion. For example, as shown in FIG. 6B, second heat capturing portion 150 extends in second direction D2, because its length is substantially aligned with second direction D2.

The purpose of first capturing portion 140 and of second capturing portion 150 is generally identical to that of first and second heat capturing portions 54, 56 of heat conducting a plate assembly 46 of WO'779, shown herein in FIGS. 1 and 2. That is, first heat capturing portion 140 is configured to be thermally coupled to heating unit 28 of heated conveyor pump 10; and second heat capturing portion one 50 is configured to be thermally coupled to medium leading section 42 of carrier unit 26 of heated conveyor pump 10.

Measurement portion 160 is configured to be thermally coupled to a temperature sensing unit 200, as shown for example in FIG. 6A. In particularly preferred embodiments, a temperature sensing unit for use with the conducting element of the first aspect comprises a housing, such as housing 220 shown in the figures, and a sensor plate, such as sensor plate 210 shown in the figures.

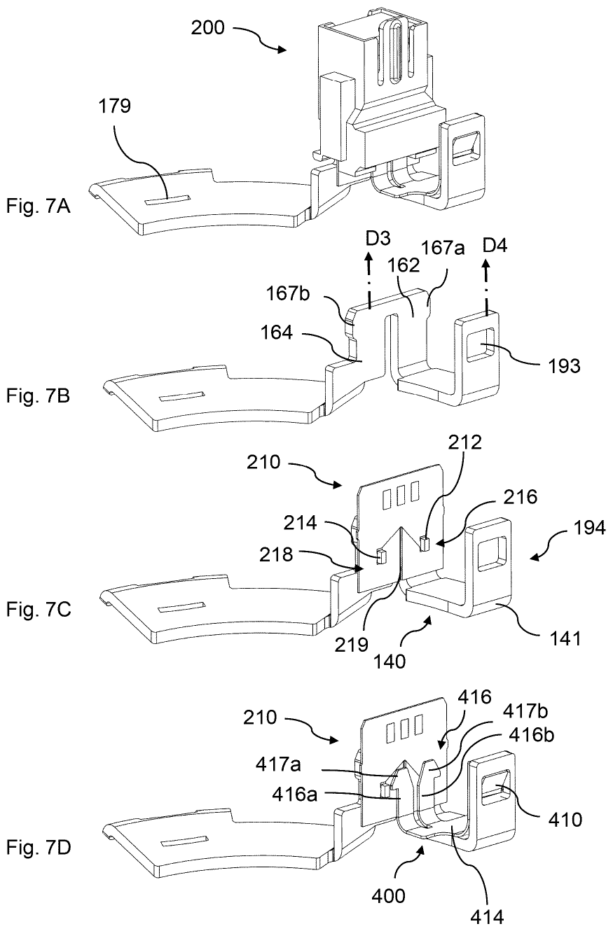

In preferred embodiments, such as those shown in the figures, measurement portion 160 comprises a first temperature sensing portion 162 and a second temperature sensing portion 164. First temperature sensing portion 162 and second temperature sensing a portion 164 generally correspond to first and second heat releasing plate portions 58, 60 of heat conducting a plate assembly 46 of WO 779. As can be inferred in particular from FIGS. 7B and 7C, sensor plate 210 comprising a first temperature sensor 212 and a second temperature sensor 214, can be thermally coupled to measurement portion 160 such that first temperature sensor 212 is capable of sensing a temperature of first temperature sensing portion 162 (also referred to as first temperature), and second temperature sensor 214 is capable of sensing a temperature second sensing portion 164 (also referred to as second temperature).

In some embodiments, such as those depicted in the figures, first temperature sensing portion 162 and second temperature sensing portion 164 are separated by a recess 166. In some embodiments, such as those depicted in the figures, first temperature sensing portion 162 and second temperature sensing portion 164 are connected by a connecting portion, such as a connecting bridge 168. In preferred embodiments, such as those depicted in the figures, a connecting portion, such as connecting bridge 168, is positioned at an end portion of measurement portion 160 that is opposite of an end portion of measurement portion 160 from which first and second heat capturing portions 140, 150 extend.

In particularly preferred embodiments, such as those depicted in the figures, and which will be further described below in conjunction with the method of the second aspect and FIG. 10, heat conducting element 100 is formed from a single piece of material. In some embodiments, the single piece of material is a sheet metal, preferably one of steel, aluminium, an aluminium alloy, copper, a copper alloy. In other embodiments, the single piece of material is a polymeric material, preferably a composite material, more preferably a composite material which includes a filler having particularly good heat conduction properties, such as copper, aluminium or other metal particles.

In preferred embodiments, such as those depicted in the figures, a connecting portion, such as connecting bridge 168, is the only portion of heat conducting element 100 which provides a material connection between the first and second temperature sensing portions 162, 164 and the first and second heat capturing portions 140, 150. In some embodiments, such as those depicted in the figures, first heat capturing portion 140 and the temperature sensing portion 162 define a first part, such as first part 180, of heat conducting element 100. In some embodiments, such as those depicted in the figures, second heat capturing portion 150 and second temperature sensing portion 164 define a second part, such as second part 190, of the heat conducting element. In some embodiments, such as those depicted in the figures, the connecting portion, such as connecting bridge 168, is the only material connection between first part 180 and second part 190.

In other preferred embodiments, which will be further described below in conjunction with the method of the second aspect and FIG. 10, a recess, such as recess 166, fully separates first and second temperature sensing portion 162, 164. In some embodiments, heat conducting element 100 is thereby fully separated into two parts, such as first part 180 and second part 190, such that there is no material connection between the first part and the second part. In some embodiments, a cut, such as cut 170, in a connection portion, such as connecting bridge 168, is provided to fully separate heat conducting element 100 into two parts such that there is no material connection between first part 180 and second part 190. Preferably, the step of performing cut 170 is performed after heat conducting element 100 has been shaped as shown in FIG. 6B, i.e. after transforming a flat shape, such as the shape of FIG. 10, into a three dimensional shape, such as the shape of FIG. 6B. In some embodiments, cut 170 is provided after heat conducting element 100 has been attached to carrier element 26. Thereby, proper positioning of first part 180 relative to second part 190 is facilitated.

Cut 170 leaves cutting marks in first part 180 and second part 190, the particulars of which depend on the combination of material of the single piece of material and the separation method used. For example, in some embodiments, heat conducting element 100 is formed from a single piece of sheet metal, and cut 170 is performed by shearing, also known as die-cutting. Shearing typically leaves two distinct sections in a cutting plane, a first section being plastic deformation and a second section being fractured. Other separation methods, such as sawing, laser cutting or water cutting, will leave other distinct marks.

In particularly preferred embodiments comprising a heat conducting element of the first aspect and a sensor plate of a temperature sensing unit, the sensor plate is provided in the form of a printed circuit board 48 as shown in FIG. 6 of WO'779. The description of WO'779 in conjunction with printed circuit board 48, in particular with reference to FIG. 6 of WO'779 is incorporated by reference in its entirety. Alternatively or additionally, the sensor plate for use with the first aspect is a printed circuit board. Alternatively or additionally, the first and/or second temperature sensors of the sensor plate for use with the first aspect are negative temperature coefficient thermistors (so called NTCs), wherein resistance decreases as temperature rises.

FIGS. 5A and 6B in particular demonstrate the spatial relationship between first and second heat capturing portions 140, 150 and measurement portion 160, according to preferred embodiments of the first aspect. In some embodiments, such as depicted in FIG. 5A, first direction D1 in which first heat capturing a portion 140 extends, corresponds to a circumferential direction of a first circle C1. In some embodiments, such as depicted in FIG. 5A, second direction D2 in which second heat capturing a portion 150 extends, corresponds to a circumferential direction of a second circle C2. In other embodiments, such as depicted in FIG. 6B, direction D1 is tangential to first circle C1. In other embodiments, one or both of first and second direction D1, D2 are tangential to a respective circle C1, C2.

In some embodiments, such as those depicted in the figures, first and second circle C1, C2 are concentric. In some embodiments, such as those depicted in the figures, first and second circles C1, C2 are concentric with a central axis 49 of circular, disc-shaped carrier unit 26. In some embodiments, such as those depicted in the figures, first and second circle C1, C2 are of different radius. In some embodiments, such as those depicted in the figures, first circle C1 fully encloses second circle C2, i.e. without perimeters of first and second circle C1, C2 intersecting. Preferably, such as depicted in the figures, a radius R1 (also referred to as first radius R1) of first circle C1 is larger than a radius R2 (also referred to as second radius R2) of second circle C2. In other embodiments, the situation is reversed, with radius R2 being larger than radius R1. In yet other embodiments, radius R1 and radius R2 are equal. In some embodiments, such as those depicted in the figures, first and second directions D1, D2 are opposite directions, meaning that one of them, such as first direction D1, extends from measurement portion 160 in a clock-wise direction, and the respective other, such as second direction D2, extends from measurement portion 160 in a counter clock-wise direction.

In the embodiments depicted in the figures, and as can particularly be inferred from FIG. 5A, first circle C1 coincides with a circular top surface 43 of heating unit 28 (also referred to as first top surface 43). First top surface 43 is a surface of heating unit 28 at which first heat capturing portion 140 is preferably brought into contact, i.e. thermally coupled, with heating unit 28. In some embodiments, the contact is direct, i.e. without any elements separating first heat capturing portion 140 and first top surface 43 of heating unit 28. In preferred embodiments, first heat capturing portion 140 is attached to first top surface 43 of heating unit 28 by welding or soldering. In some embodiments, a thermally conductive material is provided between first top surface 43 and first heat capturing portion 140. In some embodiments, the weld or solder forms such a thermally conductive material. In alternative embodiments, the thermally conductive material also has electrically isolating properties, such as a polyimide foil (e.g., Kapton MT).

Because first circle C1 coincides with circular top surface 43 of heating unit 28, and first heat capturing portion 140 extends in first direction D1 which is at least tangential to first circle C1, a contact area between first heat capturing portion 140 and heating unit 28 is increased, thereby facilitating heat transfer between first heat capturing portion 140 and heating unit 28.

Likewise, in some embodiments, such as those depicted in the figures, second circle C2 coincides with a circular top surface 45 of medium leading section 42 (also referred to as second top surface 45). Second top surface 45 is a surface of medium leading section 42 at which second heat capturing portion 150 is preferably brought into contact, i.e. thermally coupled, with medium leading section 42. The preceding considerations regarding first top surface 43, first heat capturing portion 140, first circle C1 and first direction D1 apply mutatis mutandis to second top surface 45, second heat capturing portion 150, second circle C2 and second direction D2.

Together, first top surface 43 and second top surface 45 can provide a coupling portion 44 of heating system component 18, the coupling portion 44 configured for receiving heat conducting element 100. In some embodiments, first top surface 43 and/or second top surface 45 are substantially orthogonal to central axis 49 of disc-shaped carrier unit 26. In other embodiments, first top surface 43 and/or second top surface 45 are sloped with respect to a plane orthogonal to central axis 49 of disc-shaped carrier unit 26. In particular embodiments, such as depicted in FIG. 5B, second top surface 45 is sloped radially inward. In this context, a radially inwardly sloped surface is a surface which would cause a freely movable body placed thereon to move towards central axis 49, provided that central axis 49 substantially coincides with the direction of gravity, and second top surface 45 is facing upwards. In other embodiments, second top surface 45 is sloped radially outward, i.e. a freely movable body placed thereon would move outward and away from central axis 49. In some embodiments, first top surface 43 is sloped radially inward or radially outward. Sloping one or both of first and second top surfaces 43, 45, can help position heat conducting element 100 on heating system component 18.

In some embodiments, such as those depicted in the figures, first heat capturing portion 140 extends in first direction D1 from a location at first temperature sensing portion 162. In some embodiments, such as those depicted in the figures, first heat capturing portion 140 extends from a first bend 163 provided at first temperature sensing portion 162. In some embodiments, such as those depicted in the figures, first heat capturing portion 140 extends from a portion of measurement portion 160 opposite a free end portion 161. Preferably, free end portion 161 is a portion of measurement portion 160 from which temperature sensing unit 200 can be attached to measurement portion 160. In some embodiments, first bend 163 is provided at portion of measurement portion 160 that is opposite free end portion 161.

In some embodiments, such as those depicted in the figures, second heat capturing portion 150 extends in second direction D2 from a location at second temperature sensing portion 164, preferably from a second bend 165. The preceding considerations regarding first heat capturing portion 140, free end portion 161 of temperature sensing portion 160 and first bend 163 apply mutatis mutandis to second heat capturing portion 150 and second bend 165.

In some embodiments, heat conducting element 100 further comprises a positioning portion, such as positioning portion 175, configured to engage groove 34 of carrier unit 26. As shown e.g. in FIG. 6B, positioning portion 175 is preferably provided at second heat capturing portion 150. In other embodiments, positioning portion 175 is provided at one of first heat capturing portion 140 and measurement portion 160. Preferably, positioning portion 175 extends away from second direction D2 (or first direction D1 if provided on first heat capturing portion 140), in a direction generally radially outwardly with respect to central axis 49 and/or second circle C2 (or first circle C1 if provided on first heat capturing portion 140). Preferably, positioning portion 175 is configured to engage groove 34 of carrier unit 26. In the embodiment of e.g. FIG. 6B, positioning portion 175 is substantially hook shaped for this purpose. Moreover, in the preferred embodiment of FIG. 6B, positioning portion 175 comprises a pair of hook like protrusions 176a, 176b. In some embodiments, positioning portion 175 is formed in an embodiment of the method of the second aspect, for example by bending a portion of flat material at bending lines 178a, 178b shown in FIG. 10.

In some embodiments, heat conducting element 100 can be configured to receive an electric connector 300 configured to connect heat conducting element 100 for example to electric ground and/or electric neutral, or for ensuring the electromagnetic compatibility of heated conveyor pump 10. In some embodiments, such as those depicted in the figures, a slit 179 is provided, preferably in second heat capturing portion 150, shaped to receive a connecting tongue 310 of connector 300. Connecting tongue 310 is shaped to receive a plug of a connecting cable. In some embodiments, such as those depicted in the figures, connector 300 further comprises a positioning extension 320, which serves a similar purpose as positioning portion 175. Alternatively or additionally, positioning extension 320 provides stability to connector 300 against bending and other loads applied when the plug of the grounding cable is attached to positioning portion 175. Alternatively or additionally, positioning extension 320 can serve to establish a permanent connection, in particular a permanent electric connection, between connector 300 and carrier unit 26, for example by welding, soldering, gluing or other suitable attachment methods. In some embodiments, such as those depicted in the figures, pair of hook like protrusions 176a, 176b are separated to provide a receiving space 177 for positioning extension 320 of connector 300.

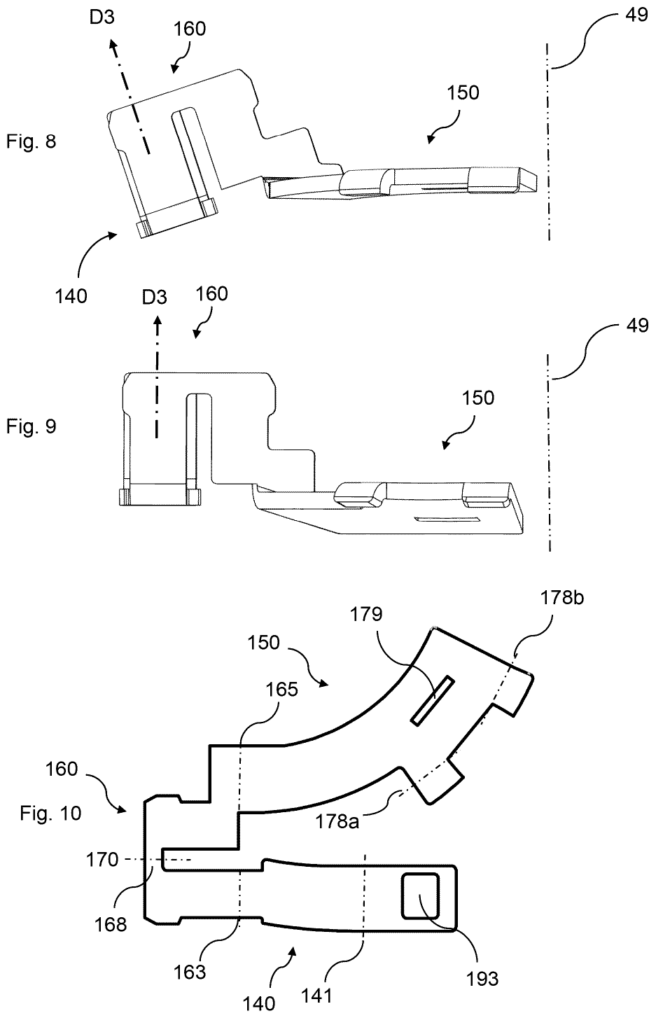

FIGS. 8 and 9 depict preferred embodiments of heat conducting element 100 adapted to conform with different radially sloped first and second top surfaces 43, 45. In FIG. 9 second heat capturing portion 150 is sloped radially inward to conform with radially inwardly sloped second top surface 45 shown in FIG. 5B. In another embodiment shown in FIG. 8, first heat capturing portion 140 is sloped radially outwardly to confirm with a radially outwardly sloped first top surface 43. Central axis 49 of disc-shaped carrier element 26 is indicated in FIGS. 8 and 9 for reference.

In some embodiments, such as those depicted in the figures, measurement portion 160 extends in a third direction D3. Preferably, such as depicted in FIG. 6B, third direction D3 is not coplanar with a plane defined by first heat capturing portion 140 and a plane defined by second heat capturing portion 150. In the context of the present application, first and second heat capturing portions 140, 150 define respective planes wherein their respective widths and lengths serve as basis vectors. In other words, a plane defined by one of the first or second heat capturing portion 140, 150 is a plane that is orthogonal to a thickness of the respective first or second heat capturing portion 140, 150. With respect to the planes defined by the first and second heat capturing portions 140, 150, third direction D3 can also be referred to as extending substantially upwards. In some embodiments, such as shown e.g. in FIG. 9, heat conducting element 100 is configured such that third direction D3 is substantially parallel to central axis 49 when attached to carrier unit 26. In other embodiments, such as shown e.g. in FIG. 8, heat conducting element 100 is configured such that third direction D3 is angled with respect to central axis 49 when attached to carrier unit 26. However, in the embodiment of FIG. 8, third direction D3 still extends generally upwards in that it has a component that is parallel to central axis 49.

Preferably, third direction D3 is a direction along which temperature sensing unit 200 can be removed from measurement portion 160. In other words, third direction D3 is preferably a direction opposite a direction along which temperature sensing unit 200 is advanced over measurement portion 160 to attach temperature sensing unit 200. In preferred embodiments, temperature measurement portion 160 has retention ears 167a, 167b extending on opposite sides of temperature measurement portion 160 and configured to assist in retaining temperature sensing unit 200 against unintended removal. Preferably, retention ears 167a, 167b are configured to engage with corresponding flexible portions in housing 220 of temperature sensing unit 200.

In some embodiments, such as those depicted in the figures, heat conducting element 100 further comprises a biasing element receiving portion 192. In some embodiments, such as those depicted in the figures, biasing element receiving portion 192 is formed to provide a substantially U-shaped portion, wherein a first leg of the U-shape is provided by at least a portion of measurement portion 160, preferably by first temperature sensing portion 162, a second leg of the U-shape is provided by an extension portion 194, and a base portion of the U-shape is provided by at least a portion of first heat capturing portion 140. Biasing element receiving portion 192 is configured to receive a biasing element 400, which is configured for biasing temperature sensing unit 200 against measurement portion 160.

In some embodiments, such as those depicted in the figures, extension portion 194 extends from a third bend 141, provided at an end portion of first heat capturing portion 140 that is opposite an end portion of first heat capturing portion 140 at which first heat capturing portion 140 extends from measurement portion 160. In some embodiments, such as those depicted in the figures, extension portion 194 extends in a fourth direction D4. Preferably, such as depicted in FIGS. 6B and 7B, fourth direction D4 is similar to third direction D3 in that fourth direction D4 is not coplanar with a plane defined by first heat capturing portion 140 and a plane defined by second heat capturing portion 150. In particularly preferred embodiments, such as those depicted in the figures, fourth direction D4 is substantially parallel to third direction D3.

In some embodiments, such as those depicted in the figures, biasing element receiving portion 192 further comprises a retention element receiving portion 193, configured to receive a retention element 410 of biasing element 400. Retention element 410 is configured to retain biasing element 400 in biasing element receiving portion 192 by engaging retention element receiving portion 193. In some preferred embodiments, retention element receiving portion 193 is provided in the form of an opening in extension portion 194. Preferably, retention element receiving portion 193 is provided closer to free end portion 142 of extension portion 194 than to third bend 141.

In particularly preferred embodiments, such as those depicted in the figures, biasing element 400 is shaped from a flat piece of spring metal, such as spring steel. In embodiments in which biasing element receiving portion 192 is generally U-shaped, biasing element 400 is likewise U-shaped. Preferably, a first leg 412 of U-shaped biasing element 400 is configured to contact extension portion 192. Preferably, a base 414 of biasing element 400 is configured to contact first heat capturing portion 140. Preferably, a second leg 416 of U-shaped biasing element 400 is configured to contact temperature sensing unit 200, when temperature sensing unit 200 is attached to heat conducting element 100. In some preferred embodiments, retention element 410 is provided as a tab protruding out of a plane of first leg 412.

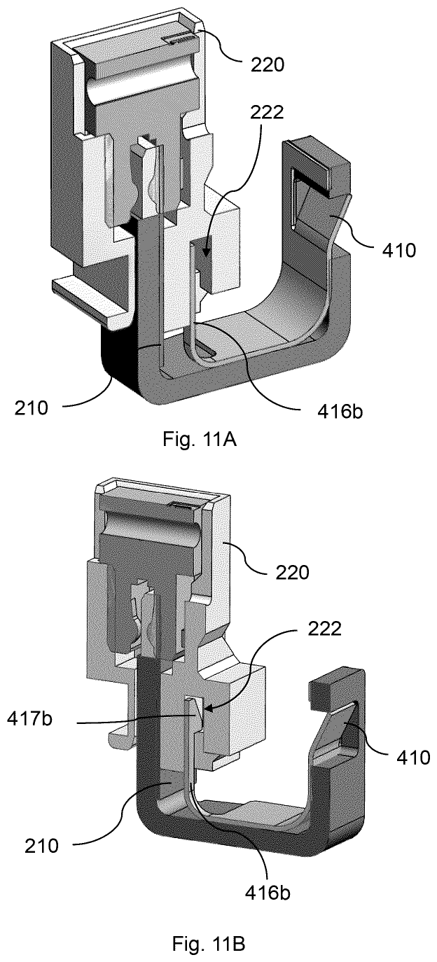

As can be inferred from a comparison between FIGS. 7A and 7D, in some preferred embodiments, second leg 416 is configured to extend into housing 220 of temperature sensing unit 200. FIGS. 11A and 11B provide cross-sectional views of measurement portion 160, first heat capturing portion 140, biasing element receiving portion 192, biasing element 400 and temperature sensing unit 200. FIGS. 11A and 11B illustrate how second leg 416 extends into housing 220 and is received in a biasing element receiving slot 222 provided in housing 220. In preferred embodiments, such as shown in FIGS. 11A and 11B, biasing element receiving slot 222 also includes lateral recesses for receiving retention protrusions 417a, 417b. Biasing element receiving slot 222 provides a contact surface against which biasing element 400 can exert its biasing force, without coming into direct contact with sensor plate 210. In embodiments in which biasing element 400 is made from metal, such as spring steel, direct contact with sensor plate 210 needs to be avoided in order to prevent short circuiting NTCs 212, 214. In other embodiments, second leg 416 is configured to be in contact with an outer surface of housing 220.

Moreover, in some preferred embodiments, such as shown in FIG. 7D, second leg 416 is forked into a pair of biasing prongs 416a, 416b. Each one of biasing prongs 416a, 416b is configured to contact a respective one of first and second sensor portions 216, 218 of sensor plate 210, which each include one of first and second sensor 212, 214, respectively.

In some preferred embodiments, such as shown in FIG. 7C, first and second sensor portions 216, 218 are separated by a slit 219, which provides first and second sensor portions 216, 218 with some bending flexibility. In conjunction with biasing prongs 416a, 416b, proper contact between first and second sensor portions 216, 218 and first and second temperature sensing portions 162, 164 can be facilitated, contributing to good thermal conductivity between first and second sensor portions 216, 218 and first and second temperature sensing portions 162, 164.

In some embodiments, such as depicted in FIG. 7D, second leg 416 has retention protrusions 417a, 417b, configured to assist in retaining second leg 416 within housing 220 of temperature sensing unit 200.

As mentioned above, FIG. 10 shows an embodiment of a flat piece of material from which a heat conducting element 100 can be formed in a manufacturing method of the second aspect. In some embodiments, the flat piece of material is provided in a shape that defines first heat capturing portion 140, second heat capturing portion 150, and measurement portion 160. In general, the flat piece of material can be shaped to define any of the portions of heat conducting element 100 discussed above. In the embodiment shown in FIG. 10, the flat piece of material is shaped to define the portions of heat conducting element 100 shown e.g. in FIG. 6B.

In some embodiments of the method of the second aspect, the flat piece of material is shaped in a first step so as to define the aforementioned portions of heat conducting element 100. Shaping can be performed for example by cutting the flat piece of material accordingly.

In some embodiments, a second step of the method of the second aspect comprises shaping the flat piece of material such that first heat capturing portion 140 extends from measurement portion 160 in first direction, second heat capturing portion 150 extends from measurement portion 160 in a second direction, and first and second heat capturing portions 140, 150 are arranged on opposite sides of the measurement portion.

In some embodiments, the second step can comprise bending the flat piece of material along aforementioned bend lines 163, 165, 178a, 178b, 141 to transform the flat piece of material into the above described three-dimensional configuration of heat conducting element 100.

In some embodiments, the method further comprises a third step comprising separating first heat capturing portion 140 and second heat capturing portion 150 such that heat conducting element 100 is divided into first part 180 and second part 190 as described above. In some preferred embodiments, as described above, heat conducting element 100 comprises no material connection between first part 180 and second part 190 after separating first heat capturing portion 140 and second heat capturing portion 150. In preferred embodiments, as described above, the third step comprises cutting a connecting portion, such as connecting bridge 168, for example along cutting line 170. In the embodiments shown in the figures, cutting line 170 extends in third direction D3. In other embodiments, cutting line 170 is perpendicular to third direction D3, and preferably located at free end portion 161 to sever connecting bridge 168 from first heat capturing portion 140 and second heat capturing portion 150.

1. A heat conducting element for use in a heating system component of a heated conveyor pump, the heat conducting element comprising:
a first heat capturing portion configured to be thermally coupled to a heating unit of the heated conveyor pump;
a second heat capturing portion configured to be thermally coupled to a medium leading section of a carrier unit of the heated conveyor pump; and
at least one measurement portion positioned between the first heat capturing portion and the second heat capturing portion and configured to be thermally coupled to a temperature sensing unit;
wherein the first heat capturing portion extends from the measurement portion in a first direction and the second heat capturing portion extends from the measurement portion in a second direction such that the first and second heat capturing portions are arranged on opposite sides of the measurement portion.

2. The heat conducting element of claim 1, wherein the first direction is at least tangential to a circumferential direction of a first circle and/or the second direction is at least tangential to a circumferential direction of a second circle.

3. The heat conducting element of claim 2, wherein the first circle is concentric with the second circle.

4. The heat conducting element of claim 2, wherein the first circle has a first radius and the second circle has a second radius, wherein the first radius is equal to or greater than the second radius.

5. The heat conducting element of claim 1, wherein the measurement portion comprises at least a first temperature sensing portion and a second temperature sensing portion.

6. The heat conducting element of claim 5, wherein the first heat capturing portion extends in the first direction from a location at the first temperature sensing portion, and wherein the second heat capturing portion extends in the second direction from a location at the second temperature sensing portion.

7. The heat conducting element of claim 5, wherein the first temperature sensing portion and the temperature sensing portion are at least partially separated by a recess.

8. The heat conducting element of claim 5, wherein the first temperature sensing portion and the temperature sensing portion are connected by a connecting portion.

9. The heat conducting element of claim 1, wherein the heat conducting element is formed from a single piece of material.

10. The heat conducting element of claim 7, wherein the recess fully separates the first heat capturing portion and the second heat capturing portion such that the heat conducting element is divided at least into a first part and a second part, and such that the heat conducting element comprises no material connection between the first part and the second part.

11. The heat conducting element of claim 10, wherein the heat conducting element is divided into the first and second part by a cut in a connecting portion connecting the first heat capturing portion and the second heat capturing portion.

12. The heat conducting element of claim 11, wherein the heat conducting element is formed from a single piece of material that is divided into the first part and the second part by the cut in the connecting portion.

13. The heat conducting element of claim 1, wherein the measurement portion extends in a third direction that is not coplanar with a plane defined by the first heat capturing portion and/or a plane defined by the second heat capturing portion.

14. The heat conducting element of claim 1, further comprising a biasing element receiving portion configured to receive a biasing element for biasing the temperature sensing unit against the measurement portion.

15. A heating system component comprising:
a heat conducting element as defined in claim 1; and
at least one temperature sensing unit thermally coupled to the measurement portion, the temperature sensing unit comprising at least a sensor board including a first temperature sensor and a second temperature sensor;
wherein the temperature sensing unit is configured such that the first temperature sensor is capable of sensing a first temperature indicative of a temperature of the heating unit of the heated conveyor pump, and such that the second temperature sensor is capable of sensing a second temperature indicative of a temperature of a medium of the medium leading section of the heated conveyor pump.

16. A method for manufacturing a heat conducting element for use in a heating system component of a heated conveyor pump, the method comprising the steps of:
a) providing a flat piece of material, wherein the flat piece of material is shaped to define at least:
a first heat capturing portion configured to be thermally coupled to a heating unit of the heated conveyor pump;
a second heat capturing portion configured to be thermally coupled to a medium leading section of a carrier unit of the heated conveyor pump; and
a measurement portion positioned between the first heat capturing portion and the second heat capturing portion and configured to be thermally coupled to a temperature sensing unit;
b) deforming the flat piece of material such that:
the first heat capturing portion extends from the measurement portion in a first direction;
the second heat capturing portion extends from the measurement portion in a second direction; and
the first and second heat capturing portions are arranged on opposite sides of the measurement portion.

17. The method of claim 16, further comprising the step of:
c) separating the first heat capturing portion and the second heat capturing portion such that the heat conducting element:
is divided at least into a first part and a second part, and
comprises no material connection between the first part and the second part.
